(19) United States
(12) Patent Application Publication
(10) Pub. No.: US 2016/0332219 A1
(43) Pub. Date: Nov. 17, 2016

(54) METHOD FOR PRODUCING B4C/AL NEUTRON-ABSORBING MATERIAL SHEET BY CONTINUOUS CAST ROLLING

(71) Applicants: China Nuclear Power Engineering Co., Ltd., Shenzhen (CN); Graduate School at Shenzhen, Tsinghua University, Shenzhen (CN); China General Nuclear Power Group, Shenzhen (CN)

(72) Inventors: Guogang Shu, Shenzhen (CN); Qiulin Li, Shenzhen (CN); Zhiyuan Luo, Shenzhen (CN); Wei Liu, Shenzhen (CN); Yanzhang Liu, Shenzhen (CN); Xin Wang, Shenzhen (CN); Xuejun Li, Shenzhen (CN); Tengfei Zhang, Shenzhen (CN)

(21) Appl. No.: 15/220,440

(22) Filed: Jul. 27, 2016

Related U.S. Application Data
(63) Continuation of application No. PCT/CN2015/071767, filed on Jan. 28, 2015.

(30) Foreign Application Priority Data
Jan. 28, 2014 (CN) 201410042799.0

(51) Int. Cl. B22D 11/00; B22D 11/115; G21F 1/08; B22D 21/00; C22C 21/00; C22C 32/00; B22D 11/06; B22D 11/12

(52) U.S. Cl. CPC B22D 11/003; B22D 11/0622; B22D 11/0642; B22D 11/115; B22D 11/122; B22D 21/007; C22C 21/00; C22C 32/0057; G21F 1/08

(57) ABSTRACT

The present invention provides a method for producing B4C/Al neutron-absorbing material sheet by continuous cast rolling including the steps of: 1) providing B4C particles and aluminum matrix melt, adding the B4C particles into the aluminum matrix melt while stirring the composite of the B4C particles and the aluminum matrix melt; 2) applying an electromagnetic field to the B4C particle-containing aluminum matrix melt passing through a headbox; 3) applying an ultrasonic vibration to the B4C particle-containing aluminum matrix melt passing through a casting nozzle; and 4) conducing twin roll continuous cast rolling on the B4C particle-containing aluminum matrix melt from the casting nozzle to obtain B4C/Al neutron-absorbing material sheet. The method of the present invention uses twin roll continuous cast rolling under coupled ultrasonic and electromagnetic oscillation to rapidly cool and refine the grains of the solidified composite material and realize uniform distribution of B4C particles in the aluminum matrix.

### CROSS-REFERENCE TO RELATED APPLICATIONS

The present application is a Continuation Application of PCT Application No. PCT/CN2015/071767 filed on Jan. 28, 2015, which claims the benefit of Chinese Patent Application No. 201410042799.0 filed on Jan. 28, 2014. All the above are hereby incorporated by reference.

### TECHNICAL FIELD

The present invention generally relates to composites and, more particularly, to a method for producing B4C/Al neutron-absorbing material sheet by continuous cast rolling.

### BACKGROUND

In nuclear energy technical field, nuclear fuel in the reactor will turn into spent fuel after a certain amount of working time. The unloaded spent fuel having very strong radiation needs to be stored properly. Sheet of B4C/Al composite having high content of B4C has been widely used in commercial application as neutron-absorbing material for storing spent fuel. The performances of B4C/Al composite mainly depends on the mass content of B4C particles, the dispersion of the B4C particles in the matrix, the interface of the matrix and the B4C particles, as well as the microstructure of the matrix.

At present, methods for producing B4C/Al neutron-absorbing material mainly includes powder metallurgy method, melt infiltration method and stirring casting method, in which stirring casting method is the most promising method for producing B4C/Al neutron-absorbing material due to high production efficiency, simple process flow and suitability for mass production.

Conventional stirring casting method for producing B4C/Al composite generally includes the steps of aluminum ingot smelting, mixing the composite, casting, saw cutting and surface milling, heating, cogging and hot rolling. Generally, the production efficiency and degree of automation of the conventional stirring casting method for producing B4C/Al composite are very low. Due to the slow cooling rate in the casting process, uniformity of the B4C particles in the B4C/Al composite sheet is unsatisfactory, which may adversely affect neutron absorbing property and other mechanical properties of the B4C/Al composite.

In mass production, the solidification rate of alloy in conventional casting billet producing method is very slow, which will inevitably lead to some defects, such as microstructure segregation. The aluminum matrix melt containing high mass content of B4C particles has large viscosity and poor fluidity. During the casting process, the aluminum matrix melt containing high mass content of B4C particles can't feeding in time, which may lead to defects, such as contraction cavities and shrinkage porosity. In addition, the B4C particles acting as heterogeneous cores have poor wettability in the aluminum matrix. During the solidification process, due to the crowding out effect of the matrix solidification front to the B4C particles, the B4C particles cannot disperse uniformly in the aluminum matrix.

Twin roll continuous cast rolling is a molding process which has the advantages of the rapid solidification and hot rolling deformation. During twin roll continuous cast rolling, the cast rolls act as crystallizer and hot rolls. In casting rolling, the solidification rate of the liquid metal is very high (as high as 103-104° C./s), so that the reinforcement can distribute homogeneously in the matrix and the defects in the composite are reduced remarkably, which not only can improve the strength of the composite, but also can ensure the ductility and deformability of the material.

X. Grant Chen et al. of Alcan Company (company of Canada) disclose in “DEVELOPMENT OF Al-30% B4C METAL MATRIX COMPOSITES FOR MEUTRON ABSORBER MATERIAL” that sheet of B4C/Al composite having 30% B4C by mass can be produced via stir-mixing process in laboratory and extrusion or hot rolling process. However, during solidification, the B4C particles intend to gather in the center area. Even extrusion or hot rolling process can improve uniformity of the B4C particles, the B4C/Al composite, especially B4C/Al composite having high mass content of B4C particles, has high hardness and poor deformation processing performances and, therefore, it is difficult to produce sheet via cold rolling. At present, repeated hot rolling is implemented on casting ingots, which will remarkably increase the producing cost.

NIE can zhu of Shanghai Jiao Tong University discloses a method for producing a B4C/Al composite containing 10% by volume of B4C particles via stirring method in his Ph. D. theses, titled “Research of Fabrication and Weldability of Boron Carbide Particulates Reinforced Aluminum Matrix composites”. However, due to severe interface reaction, the mechanical properties of the composite are poor and the volume content of the B4C particles is not high enough. Japanese scholar T. Haga discloses in an article titled “Roll casting of Al-SiCp strip” that after stirring and mixing, twin roll continuous cast rolling technology is used to directly roll the composite containing 20% and 30% by volume of SiCp, so as to obtain a sheet material having a thickness of 2.0 mm and 1.7 mm. The uniformity of the particles in the sheet material is higher than that of the sheet material produced by conventional casting methods. In addition, the sheet material is suitable for following cold rolling or hot rolling. However, analysis shows that the uniformity of the particles in the sheet material after continuous rolling is still not satisfactory enough.

In view of the foregoing, what is needed, therefore, is to provide a method for producing B4C/Al neutron-absorbing material sheet by continuous cast rolling which can ensure uniform distribution of B4C particles in the aluminum matrix.

### BRIEF SUMMARY OF VARIOUS EMBODIMENTS OF THE INVENTION

One object of the present invention is to provide a method for producing B4C/Al neutron-absorbing material sheet by continuous cast rolling which can ensure uniform distribution of B4C particles in the aluminum matrix.

According to one embodiment of the present invention, a method for producing B4C/AL neutron-absorbing material sheet by continuous cast rolling including the steps of:

1) providing B4C particles and aluminum matrix melt, adding the B4C particles into the aluminum matrix melt while stirring the composite of the B4C particles and the aluminum matrix melt;

2) applying an electromagnetic field to the B4C particle-containing aluminum matrix melt passing through a headbox to achieve electromagnetic dispersion;

3) applying an ultrasonic vibration to the B4C particle-containing aluminum matrix melt passing through a casting nozzle; and

4) conducing twin roll continuous cast rolling on the B4C particle-containing aluminum matrix melt from the casting nozzle to obtain a B4C/Al neutron-absorbing material sheet.

Via applying ultrasonic vibration during cast rolling process, due to the acoustic cavitation and the acoustic streaming effect, air bubbles in the aluminum matrix melt can be reduced remarkably, which can spheroidize and refine the solidified grains. The energy applied by the ultrasonic to the interface of the aluminum matrix melt and the B4C particles can promote wettability of the aluminum matrix melt on the B4C particles. Local high temperature and high pressure caused by the acoustic cavitation can clean and activate the surface of the B4C particles, so as to increase the surface energy of the particles and reduce the surface energy of the melt. The stirring of the acoustic streaming realizes macro uniform dispersion of the B4C particles. The comprehensive effect of the acoustic cavitation and the acoustic streaming can realize micro uniform dispersion of the B4C particles.

The headbox of the continuous cast rolling equipment is positioned in the space between the upper and lower iron cores. When direct current passes through the aluminum liquid and alternating current passes through the coils, the electromagnetic induction device will generate an alternating traveling magnetic field along the axis direction of the rolls and a vertical oscillating magnetic field, mainly the traveling magnetic field. In non-contact condition, the aluminum liquid generates induced current due to the changing magnetic field, which will lead to generation of changing electromagnetic force and movement of the particles in the aluminum matrix liquid. According to electromagnetism principle, complex magnetic field mainly including the traveling magnetic field and the electromagnetic induction applied to the cast rolling zone will generates horizontal stirring force parallel to the axis direction of the rolls. Via changing the direction of the traveling magnetic field, the direction of the stirring force can be changed, which will lead to abnormal and small amplitude migration flow in the solidification zone of the solidification front, so that the flow field, the temperature field and the concentration field of the melt change constantly. The changing flow field, temperature field and concentration field of the melt will provide scouring force and mechanical shear force to the dendritic at the solidification front, and leads to peel off and break of the dendritic and increases nucleation centers. Therefore, applying electromagnetic field during the continuous casting process can obtain composite sheet having refined and equiaxed grains and uniformly dispersed B4C particles.

According to one aspect of the present invention, a particle size of the B4C particles is 0-44 μm.

According to one aspect of the present invention, in step 1), the aluminum matrix melt includes ≦0.25 wt % Si, ≦0.35% wt Fe, ≦0.05 wt % Cu, ≦0.03 wt % Mn, ≦0.03 wt % Mg, ≦0.10 wt % Zn, ≦0.10 wt % Ti and ≧99.60 wt % Al.

According to one aspect of the present invention, wherein in step 1), prior to being added into the aluminum matrix melt, the B4C particles are preheated in an air atmosphere at 300° C.-500° C. for 2 h-2.5 h and fully dried in a vacuum drying oven.

According to one aspect of the present invention, in step 1), the aluminum matrix melt is obtained via melting the aluminum matrix under 5-10 Pa vacuum and setting the aluminum matrix melt at 720° C.-730° C. for 15-20 minutes while applying mechanical stirring to the aluminum matrix melt.

According to one aspect of the present invention, in step 1), the aluminum matrix melt is subjected to standing, refining and slagging-off.

According to one aspect of the present invention, in step 1), the stirring is carried out at a temperature of 690-720° C., a stirring speed of 600-800 rpm, and a mixing time of 15-30 min.

According to one aspect of the present invention, in step 2), the electromagnetic field generates an electromagnetic oscillation via interaction of a constant magnetic field and a low frequency alternating magnetic field to achieve electromagnetic dispersion.

According to one aspect of the present invention, in step 2), the constant magnetic field adopts a direct current of 180 A-200 A, a coil turns of 80-120, a magnetic field direction of coil axis, and a magnetic field intensity of 0.1-0.4 T; the low frequency alternating magnetic field adopts an alternating current of 80 A-100 A, a coil turns of 80-120, an alternating current frequency of 20 Hz-40 Hz, a magnetic field direction of coil axis, an effective magnetic field strength of 0.05-0.3 T, and an oscillation time of 1.5-2 min.

According to one aspect of the present invention, in step 3), the ultrasonic vibration is applied from top side, the power of the ultrasonic vibration is 240 W-300 W, and the vibration time of the ultrasonic vibration is 150-180 s.

According to one aspect of the present invention, the twin roll continuous cast rolling uses copper twin rollers, the loading between the twin rollers is 25-30 KN, the rotation speed of the twin roller is 0.9-1.2 m/min, and the twin roller is cooled by water.

According to one aspect of the present invention, the mass content of the B4C particles in the B4C/Al neutron-absorbing material sheet is 20-31%.

According to one embodiment of the present invention, a B4C/Al neutron-absorbing material sheet is provided. The B4C/Al neutron-absorbing material sheet is produced according to the method of the present invention.

Compared with the prior art, the method for producing B4C/Al neutron-absorbing material sheet by continuous cast rolling of the present invention has the following advantages.

1. Twin roll continuous cast rolling can realize direct transformation from liquid to solid sheet, which can shorten the process flow, improve the processing efficiency and reduce the cost, thereby having high economic value.

2. Twin roll continuous cast rolling under coupling of ultrasonic and electromagnetic oscillation can realize quick cooling of the composite, to achieve refined grains of the solidification structure of the composite and uniform dispersion of the B4C particles without segregation.

3. Due to the ultrasonic vibration and the electromagnetic field, the B4C particles can disperse more uniformly in the matrix. The present invention is clean and free from any pollution.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention:

### BRIEF DESCRIPTION OF THE DRAWINGS

FIG. 1 shows a diagram of a method for producing B4C/Al neutron-absorbing material sheet by continuous cast rolling according to one embodiment of the present invention;

FIG. 2a shows a metallographic image (×100) of a B4C/Al neutron-absorbing material sheet having 31% by mass of B4C particles produced according to conventional casting method under an optical microscope; and

FIG. 2b shows a metallographic image (×100) of a B4C/Al neutron-absorbing material sheet having 31% by mass of B4C particles produced by the continuous cast rolling method of the present invention under an optical microscope.

### DETAILED DESCRIPTION OF THE INVENTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

1. Raw Material Selection

1) Selection of B4C particles: 325 mesh nuclear grade B4C particles produced by Mudanjiang Jingangzuan Boron Carbide Co., Ltd. are used. The particle size of the B4C particles is 0-44 μm. The average grain size of the B4C particles is 18.25 μm. The mass content of each chemical composition in the B4C particles is shown in the table below.

| | Chemical composition | | | | | | |
|---|---|---|---|---|---|---|---|
| | Total | Free | Total | Free | | Sili- | Remain- |
| | boron | boron | carbon | carbon | Fe₂O₃ | con | ing |
| Mass | 79.31 | 0.23 | 19.03 | 0.58 | 0.15 | 0.05 | 0.65 |
| content | | | | | | | |
| (%) | | | | | | | |

2) Selection of the aluminum matrix: 1060 aluminum ingot is used as the aluminum matrix. The mass content of each chemical composition in the aluminum matrix is shown in the following table.

| Element | Silicon | Iron | Cooper | Manganese | Magnesium | Zinc | Titanium | Aluminum |
|---|---|---|---|---|---|---|---|---|
| Mass | ≦0.25 | ≦0.35 | ≦0.05 | ≦0.03 | ≦0.03 | ≦0.10 | ≦0.10 | ≧99.60 |
| content | | | | | | | | |
| (%) | | | | | | | | |

The aluminum matrix is washed in dilute hydrochloric acid, wiped via alcohol and dried for use.

2. Pretreatment of the B4C particles: 4.5 kg B4C particles are preheated in air atmosphere at 300° C.-500° C. for 2-2.5 hours to remove impurities and moisture at the surface of the B4C particles. The preheated B4C particles are then sufficiently dried in a vacuum oven.

3. 10 kg aluminum ingot is melt in a vacuum environment of 5-10 Pa vacuum. The melt is set at 720° C.-730° C. (preferably 725° C.) for 15-20 minutes and subjected to mechanical agitation, so that the aluminum matrix melt has uniformly dispersed solute and temperature.

4. The aluminum matrix melt is subjected to standing, refining and slagging-off, so as to reduce air bubbles and surface oxides in the aluminum matrix melt.

5. The pretreated B4C particles are added into the aluminum matrix melt via spray method at a speed of 150 g/min. While adding the B4C particles, mechanical agitation is applied to the aluminum matrix melt.

6. Composite mixing: the B4C particle-containing aluminum matrix melt is stirred at a temperature of 690-720° C. (preferably 700° C.) with a stirring speed of 600-800 rpm. The rotation speed of stirring is 750 r/min at the beginning of stirring and maintained at 650 r/min. The mixing time is 15-30 min (preferably 20 min)

7. The headbox of the continuous casting equipment of the present invention is arranged in the space between the upper and lower iron cores of the electromagnetic induction. An electromagnetic field is applied to the B4C particle-containing aluminum matrix melt passing through the headbox. The electromagnetic field generates electromagnetic oscillation via the interaction of a constant magnetic field and a low frequency alternating magnetic field to achieve electromagnetic dispersion.

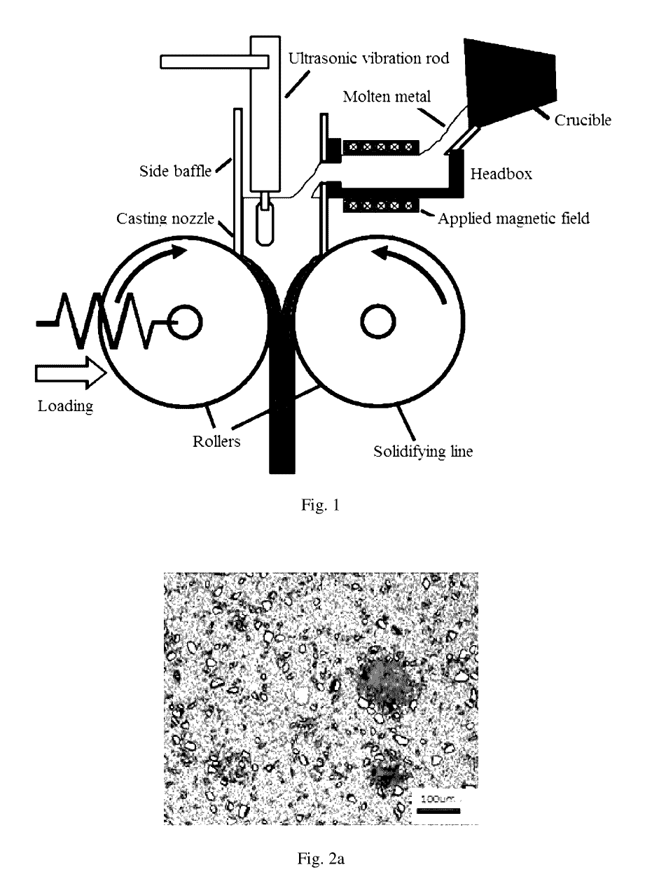

In the applied magnetic field as shown in FIG. 1, the constant magnetic field adopts a direct current of 180 A-200 A, a coil turns of 80-120, a magnetic field direction of coil axis, and a magnetic field intensity of 0.1-0.4 T; the low frequency alternating magnetic field adopts an alternating current of 80 A-100 A, a coil turns of 80-120, an alternating current frequency of 20 Hz-40 Hz, a magnetic field direction of coil axis, an effective magnetic field strength of 0.05-0.3 T, and an oscillation time of 1.5-2 min.

8. Ultrasonic vibration is applied to the B4C particle-containing aluminum matrix melt passing through the casting nozzle. As shown in FIG. 1, the ultrasonic vibration is applied from top side, the power of the ultrasonic vibration is 240 W-300 W, and the vibration time is 150-180 s.

9. Quick twin roll continuous cast rolling: the twin roll continuous cast rolling uses copper twin rollers. A loading between the twin rollers is 25-30 KN (preferably 27 KN). The rotation speed of the twin roller is 0.9-1.2 m/min. The twin rollers are cooled by water. The B4C particles in the matrix can act as separating material. Therefore, there is no need to spray separating material on the rollers and the composite is free from pollution.

It should be understood by one ordinary skilled in the art, except for the ultrasonic vibration rod and the applied magnetic field, the other components of the continuous casting equipment of the present invention are almost the same as that of the continuous casting machine in the prior art and, therefore, will not be detailed further in this application.

Compared with the prior art, the method for producing B4C/Al neutron-absorbing material sheet by continuous cast rolling according to the present invention has the following advantages.

1. Twin roll continuous cast rolling can realize direct transformation from liquid to solid sheet, which can shorten the process flow, improve the processing efficiency and reduce the cost, thereby having high economic value.

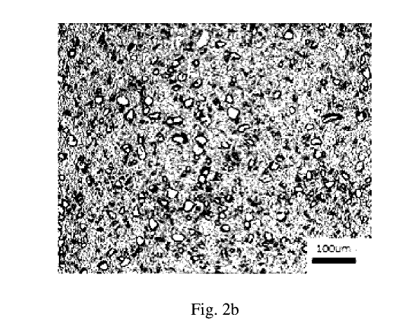

2. Twin roll continuous cast rolling under coupling of ultrasonic and electromagnetic oscillation can realize quick cooling of the composite, to achieve refined grains of the solidification structure of the composite and uniform dispersion of the B4C particles without segregation. FIG. 2a shows a metallographic image (×100) of a B4C/Al neutron-absorbing material having 31% by mass of B4C particles produced by conventional casting methods. FIG. 2b shows a metallographic image (×100) of a B4C/Al neutron-absorbing material having 31% by mass of B4C particles produced by the casting method of the present invention. Via comparison of FIG. 2a and FIG. 2b, it is clearly shown that in the B4C/Al neutron-absorbing material having 31% by mass of B4C particles produced by the conventional casting method, the B4C particles intend to aggregate and black spots intend to occur. In the B4C/Al neutron-absorbing material having 31% by mass of B4C particles produced by the method of the present invention, the B4C particles disperse uniformly in the composite, the solidification structure is refined, and there is no noticeable defect.

3. Due to the ultrasonic vibration and the electromagnetic field, the B4C particles can disperse more uniformly in the matrix. The present invention is clean and free from any pollution.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions describe example embodiments, it should be appreciated that alternative embodiments without departing from the scope of the appended claims. Although specific terms are employed herein, they are used in a generic and descriptive sense only and not for purposes of limitation.

What is claimed is:

1. A method for producing B4C/Al neutron-absorbing material sheet by continuous cast rolling, comprising the steps of:
1) providing B4C particles and aluminum matrix melt, adding the B4C particles into the aluminum matrix melt while stirring the composite of the B4C particles and the aluminum matrix melt;
2) applying an electromagnetic field to the B4C particle-containing aluminum matrix melt passing through a headbox;
3) applying an ultrasonic vibration to the B4C particle-containing aluminum matrix melt passing through a casting nozzle; and
4) conducing twin roll continuous cast rolling on the B4C particle-containing aluminum matrix melt from the casting nozzle to obtain B4C/Al neutron-absorbing material sheet.

2. The method of claim 1, wherein a particle size of the B4C particles is 0-44 μm.

3. The method of claim 1, wherein in step 1), the aluminum matrix melt comprises ≦0.25 wt % Si, ≦0.35% wt Fe, ≦0.05 wt % Cu, ≦0.03 wt % Mn, ≦0.03 wt % Mg, ≦0.10 wt % Zn, ≦0.10 wt % Ti and ≧99.60 wt % Al.

4. The method of claim 1, wherein in step 1), prior to being added into the aluminum matrix melt, the B4C particles are preheated in an air atmosphere at 300° C.-500° C. for 2 h-2.5 h and fully dried in a vacuum drying oven.

5. The method of claim 1, wherein in step 1), the aluminum matrix melt is obtained via melting the aluminum matrix under 5-10 Pa vacuum and setting the aluminum matrix melt at 720° C.-730° C. for 15-20 minutes while applying mechanical stirring to the aluminum matrix melt.

6. The method of claim 5, wherein in step 1), the aluminum matrix melt is subjected to standing, refining and slagging-off.

7. The method of claim 1, wherein in step 1), the stirring is carried out at a temperature of 690-720° C., a stirring speed of 600-800 rpm, and a stirring time of 15-30 min.

8. The method of claim 1, wherein in step 2), the electromagnetic field generates an electromagnetic oscillation via interaction of a constant magnetic field and a low frequency alternating magnetic field to achieve electromagnetic dispersion.

9. The method of claim 8, wherein in step 2), the constant magnetic field adopts a direct current of 180 A-200 A, a coil turns of 80-120, a magnetic field direction of coil axis, and a magnetic field intensity of 0.1-0.4 T; the low frequency alternating magnetic field adopts an alternating current of 80 A-100 A, a coil turns of 80-120, an alternating current frequency of 20 Hz-40 Hz, a magnetic field direction of coil axis, an effective magnetic field strength of 0.05-0.3 T, and an oscillation time of 1.5-2 min.

10. The method of claim 1, wherein in step 3), the ultrasonic vibration is applied from top side, a power of the ultrasonic vibration is 240 W-300 W, and a vibration time of the ultrasonic vibration is 150-180 s.

11. The method of claim 1, wherein in step 4), the twin roll continuous cast rolling uses copper twin rollers, a loading between the twin rollers is 25-30 KN, a rotation speed of the twin rollers is 0.9-1.2 m/min, and the twin rollers are cooled by water.

12. The method of claim 1, wherein a mass content of the B4C particles in the B4C/Al neutron-absorbing material sheet is 20-31%.

13. A B4C/Al neutron-absorbing material sheet produced by the method of claim 1.
